(19) United States
(12) Patent Application Publication
(10) Pub. No.: US 2025/0249620 A1
(43) Pub. Date: Aug. 7, 2025

(54) Chainsaw

(71) Applicant: Greenworks (Jiangsu) Co., Ltd, Changzhou (CN)

(72) Inventors: Shu Huang, Changzhou (CN); Lingao Zhang, Changzhou (CN)

(21) Appl. No.: 19/091,890

(22) Filed: Mar. 27, 2025

Related U.S. Application Data
(63) Continuation of application No. PCT/CN2023/120649, filed on Sep. 22, 2023.

(30) Foreign Application Priority Data
Sep. 27, 2022 (CN) 202222565618.5
Sep. 27, 2022 (CN) 202222565658.X
Jul. 17, 2023 (CN) 202321873960.X
Jul. 17, 2023 (CN) 202321884529.5

(51) Int. Cl. B27B 17/00

(52) U.S. Cl. CPC B27B 17/00

(57) ABSTRACT

A chainsaw includes a housing and a cutting assembly. The housing includes a central housing, a motor cover arranged obliquely upward at a tail part of the central housing, and a handle housing arranged obliquely downward at the tail part of the central housing, and a hollow structure is arranged between the motor cover and the handle housing. The cutting assembly is arranged on a front side of the central housing, an axis of the cutting assembly is intersected with an axis of the handle housing, and a first intersection thereof is located inside the handle housing.

### CROSS REFERENCE TO RELATED APPLICATION

The present application is a continuation Application of PCT application No. PCT/CN2023/120649 filed on Sep. 22, 2023, which claims the benefit of CN202222565658.X filed on Sep. 27, 2022, CN202222565618.5 filed on Sep. 27, 2022, CN202321884529.5 filed on Jul. 17, 2023, and CN202321873960.X filed on Jul. 17, 2023. All the above are hereby incorporated by reference for all purposes.

### TECHNICAL FIELD

The disclosure relates to a technical field of power tool, in particular to a chainsaw.

### BACKGROUND

Electric chainsaws use batteries to power the driving motor, thereby driving the chain to rotate. They are often used in conditions such as felling trees and pruning branches. When using a chainsaw, problems such as large vibration, difficulty in gripping, and easy wear of gears often occur.

### SUMMARY

One or more embodiments of the disclosure provide a chainsaw. The chainsaw includes a housing and a cutting assembly.

The housing includes a central housing, a motor cover and a handle housing, the motor cover arranged obliquely upward at a tail part of the central housing, the handle housing is arranged obliquely downward at the tail part of the central housing, and a hollow structure is arranged between the motor cover and the handle housing.

The cutting assembly is arranged on a front side of the central housing, an axis of the cutting assembly is intersected with an axis of the handle housing, and a first intersection thereof is located inside the handle housing.

In an embodiment of the disclosure, the axis of the cutting assembly is intersected with an axis of the motor cover, a second intersection thereof is located in the central housing, the axis of the handle housing is intersected with the axis of the motor cover, and a third intersection thereof is located in the motor cover.

In an embodiment of the disclosure, the central housing, the motor cover and the handle housing are an integrated structure.

In an embodiment of the disclosure, an air inlet is arranged on the motor cover, and the air inlet is located at the hollow structure.

In an embodiment of the disclosure, an air outlet is arranged on the motor cover close to a top of the motor cover.

In an embodiment of the disclosure, a soft rubber is arranged on the motor cover, and a holding area is arranged on a side of the motor cover opposite to the hollow structure.

In an embodiment of the disclosure, the chainsaw further includes a driving assembly, a transmission assembly and a power supply assembly.

The driving assembly is installed in the motor cover.

The transmission assembly is installed in the central housing, and in a transmission connection with the driving assembly and the cutting assembly respectively.

The power supply assembly is arranged at a tail part of the handle housing and electrically connected with the driving assembly.

In an embodiment of the disclosure, a switch is arranged in the handle housing, the switch, the driving assembly and the power supply assembly are electrically connected through a conductive wire, the conductive wire is led out from the power supply assembly, passes through an inside of the handle housing and is connected with the switch, and extends into the motor cover to be connected with the driving assembly.

In an embodiment of the disclosure, a first protective plate is further arranged above the cutting assembly, and one end of the first protective plate is rotatably connected with the central housing.

In an embodiment of the disclosure, a second protective plate is further arranged below the handle assembly, and the second protective plate is fixedly connected with a bottom of the central housing.

In an embodiment of the disclosure, a tensioning block is slidably installed on a side of the housing, a bar is arranged on the tensioning block, and a side cover is further arranged on the side of the housing where the tensioning block is arranged.

The chain saw further includes a locking knob, a spiral cam and a tensioning knob. The locking knob is installed on a side of the side cover away from the housing, and a locking bolt passes through the housing, the bar and the side cover in sequence to be threadedly connected with the locking knob.

The spiral cam is rotatably installed on the side cover, a crescent-shaped through hole is arranged on the spiral cam, a convex outer arm is arranged on an outer circumference of the spiral cam, and the convex outer arm contacts the tensioning block.

The tensioning knob is rotatably installed on an outer side of the locking knob, matched with the crescent-shaped through hole through a crescent-shaped protruding block to be clamped with the spiral cam, the tensioning knob is configured to be rotated to drive the spiral cam to rotate, so as to drive the tensioning block to move forward and backward, and then drive the bar to adjust a tension.

In an embodiment of the disclosure, a sliding groove is arranged on a side of the housing close to the side cover, a pin shaft is installed in the sliding groove, and the tensioning block is slidably installed on the pin shaft and is located in the sliding groove.

In an embodiment of the disclosure, a clamping groove is arranged at one end of the sliding groove, a first end of the pin shaft is inserted into an inner side wall of the sliding groove, a second end of the pin shaft is clamped in the clamping groove, a spring is sleeved on the pin shaft, and the spring is located between the tensioning block and the inner side wall of the sliding groove into which the pin shaft is inserted.

In an embodiment of the disclosure, a first connecting component is arranged at a first end of the tensioning block, and a second connecting component is provided at a second end of the tensioning block, the first connecting component is fixedly connected with the bar, and one end of the second connecting component passes through the bar and the side cover to contact the spiral cam.

In an embodiment of the disclosure, a nut is embedded in the locking knob and the locking knob is threadedly connected with the locking bolt through the nut.

In an embodiment of the disclosure, the side cover is provided with a concave groove, the tensioning knob is located in the concave groove, a plurality of protrusions is arranged at intervals on an outer circumference of the tensioning knob, a flat spring is installed in a housing cavity, and the flat spring is located between the inner side wall of the concave groove and an outer side wall of the tensioning knob.

In an embodiment of the disclosure, the chainsaw further includes a locking handle, the locking handle is rotatably connected with the locking knob, and a plurality of angle clamping positions is arranged on the locking knob to fix the locking handle.

One or more embodiments of the disclosure further provide a chainsaw, the chainsaw includes a housing, and the housing includes a handle housing. A housing cavity is formed at a bottom of the handle housing, a PCB board is installed in the housing cavity, and the PCB board is a brushless PCB board or a brushed PCB board. Wherein, front and rear sides of the housing cavity are provided with first positioning ribs, left and right sides of the housing cavity are provided with second positioning ribs, the brushless PCB board is fixedly installed in the housing cavity through the first positioning ribs, or the brushed PCB board is fixedly installed in the housing cavity through the second positioning ribs.

In an embodiment of the disclosure, the housing further includes a motor cover, a motor is installed in the motor cover, when the PCB board is the brushless PCB board, the motor is a brushless motor, or when the PCB board is the brushed PCB board, the motor is a brushed motor.

In an embodiment of the disclosure, the chainsaw further includes a wire, a first end of the wire is electrically connected with the PCB board, and a second end of the wire extends through the handle housing to the motor cover and is electrically connected with the motor.

In an embodiment of the disclosure, the housing includes a first housing and a second housing, and the first housing and the second housing are fixedly connected with each other to form the handle housing and the motor cover.

In an embodiment of the disclosure, auxiliary air inlets are arranged on the first housing and the second housing at positions corresponding to the housing cavity, and the auxiliary air inlets are communicated with the housing cavity.

In an embodiment of the disclosure, a wire clamping groove is arranged on an inner wall of the first housing or the second housing located at the handle housing, and the wire is fixed in the wire clamping groove.

In an embodiment of the disclosure, the chainsaw further includes a cutting assembly. The cutting assembly includes a bar and a chain, one end of the bar is connected with the housing, and the chain is arranged around the bar.

In an embodiment of the disclosure, the chain includes guiding teeth, a tooth thickness of the guiding teeth is set between 0.04 inches and 0.05 inches, and a pitch of the chain is set between 0.2 inches and 0.4 inches.

In an embodiment of the disclosure, a product ratio of the chain is set between 406 mm³ and 450 mm³.

In an embodiment of the disclosure, blades of the chain are right-angle teeth.

One or more embodiments of the disclosure provide a chainsaw. The chainsaw includes a housing, a transmission assembly, and a cutting assembly, and a motor is installed in the housing.

The transmission assembly includes a driving wheel, a driven wheel and an output shaft, the driving wheel is connected with the motor, the output shaft is installed inside the housing, and the driven wheel is installed on the output shaft.

The cutting assembly is connected with the output shaft, and the motor drives the transmission assembly to drive the cutting assembly to work.

Wherein, the driving wheel is a cylindrical gear, teeth of the driven wheel are arranged on an end surface of the driven wheel, and a meshing surface between the driving wheel and the driven wheel is a flat plane.

In an embodiment of the disclosure, bearing installation positions are arranged in the first housing and the second housing, bearings are installed at two ends of the output shaft, and the bearings are located in the bearing installation positions.

In an embodiment of the disclosure, the motor includes a motor bracket, the motor bracket is fixedly connected with the first housing and the second housing through fixing screws.

In an embodiment of the disclosure, the motor includes the motor bracket, and a motor bracket installation groove is formed in the first housing and the second housing, and the motor bracket is located inside the motor bracket installation groove.

In an embodiment of the disclosure, the driven wheel is a crown gear.

In an embodiment of the disclosure, a concave groove is formed on the top of the housing, and the concave groove is located at one end of the housing close to the cutting assembly, and one end of a protective plate is located in the concave groove.

In an embodiment of the disclosure, the chainsaw further includes a lubrication device. The lubrication device is installed on the output shaft. The lubrication device includes an automatic oil pump. An oil outlet of the automatic oil pump points to the cutting assembly.

In an embodiment of the disclosure, the motor is an external rotor motor, a diameter of the motor is set between 30 mm and 40 mm, and a length of an iron core of the motor is set between 20 mm and 40 mm.

In an embodiment of the disclosure, a whole weight of a handheld chainsaw is set between 1 kg and 1.1 kg.

One or more embodiments of the disclosure provide the chainsaw and the chainsaw separates the motor cover and the handle housing from each other through the hollow structure, so that a vibration of a holding part of a handle can be effectively reduced. The air inlet is arranged at the hollow structure, so that heat dissipation can be achieved while effectively preventing debris from entering an interior of the chainsaw and causing damage to the chainsaw. At the same time, a center of gravity of the chainsaw is moved backward in the disclosure, and the chainsaw is ergonomic during use, so as to improve user's comfort and facilitate force and hold.

One or more embodiments of the disclosure provide the chainsaw, which integrates the tensioning knob and the locking knob together to facilitate user operation, realizes integrated functions of tensioning and pressing of chain and bar in a tensioning and locking structure, and realizes tool-free adjustment.

One or more embodiments of the disclosure provide the chainsaw, which forms the housing cavity provided with the first positioning rib and the second positioning rib in the handle housing, so that the handheld chainsaw can be adapted to be installed with the brushed PCB board and the brushless PCB board, and a corresponding motor is selected according to a type of the PCB board, and the handheld chainsaw can be adapted to different types of motors, thereby improving an applicability of the handheld chainsaw.

One or more embodiments of the disclosure provide the chainsaw, which eliminates an influence of an axial error of the driving wheel by designing the driving wheel in the transmission assembly as a cylindrical gear, meshing the driving wheel with the driven wheel, and setting the meshing surface as the flat plane, thereby improving a matching accuracy of the driving wheel and the driven wheel, and preventing gear noise, tooth jamming, tooth jumping, slipping or wear.

### BRIEF DESCRIPTION OF THE DRAWINGS

In order to explain technical solutions of embodiments of the disclosure more clearly, the following will briefly introduce drawings used in a description of the embodiments or the conventional art. Obviously, the drawings in the following description are only some embodiments of the disclosure. For those of ordinary skill in the art, other drawings may be obtained based on these drawings without creative work.

FIG. 1 is a first schematic structural view of a chainsaw according to at least one embodiment of the disclosure.

FIG. 2 is a front view of the chainsaw according to at least one embodiment of the disclosure.

FIG. 3 is an enlarged schematic structural view of an area A in FIG. 2.

FIG. 4 is a first schematic structural view of the chainsaw from another angle according to at least one embodiment of the disclosure.

FIG. 5 is an enlarged schematic structural view of an area B in FIG. 4.

FIG. 6 is a first schematic internal structural view of the chainsaw according to at least one embodiment of the disclosure.

FIG. 7 is an exploded schematic structural view of the chainsaw according to at least one embodiment of the disclosure.

FIG. 8 is a schematic structural view of a housing of the chainsaw according to at least one embodiment of the disclosure.

FIG. 9 is a schematic structural view of a locking knob and a tensioning knob according to at least one embodiment of the disclosure.

FIG. 10 is an exploded schematic structural view of the locking knob and the tensioning knob according to at least one embodiment of the disclosure.

FIG. 11 is a second schematic structural view of the chainsaw according to at least one embodiment of the disclosure.

FIG. 12 is a second schematic structural view of the chainsaw from another angle according to at least one embodiment of the disclosure.

FIG. 13 is a second schematic internal structural view of the chainsaw according to at least one embodiment of the disclosure.

FIG. 14 is a schematic structural view of a first housing in the chainsaw according to at least one embodiment of the disclosure.

FIG. 15 is a schematic structural view of a housing cavity in the chainsaw according to at least one embodiment of the disclosure.

FIG. 16 is a schematic structural view of an installation of a brushless PCB board according to at least one embodiment of the disclosure.

FIG. 17 is a schematic structural view of an installation of a brushed PCB board according to at least one embodiment of the disclosure.

FIG. 18 is a schematic structural view of a wire groove inside a handle housing according to at least one embodiment of the disclosure.

FIG. 19 is a schematic installation view of a brushless motor and the brushless PCB board according to at least one embodiment of the disclosure.

FIG. 20 is a schematic installation view of a brushed motor and the brushed PCB board according to at least one embodiment of the disclosure.

FIG. 21 is a partial schematic structural view of a chain in the chainsaw according to at least one embodiment of the disclosure.

FIG. 22 is a partial schematic top view of the chain in the chainsaw according to at least one embodiment of the disclosure.

FIG. 23 is a schematic structural view of the brushed motor and a transmission assembly according to at least one embodiment of the disclosure.

FIG. 24 is an exploded schematic structural view of the transmission assembly according to at least one embodiment of the disclosure.

FIG. 25 is a schematic structural view of an installation of the brushless motor according to at least one embodiment of the disclosure.

FIG. 26 is a schematic structural view of the housing when installing the brushless motor according to at least one embodiment of the disclosure.

FIG. 27 is a schematic structural view of the housing when installing the brushed motor according to at least one embodiment of the disclosure.

FIG. 28 is an exploded schematic structural view of a first protective plate according to at least one embodiment of the disclosure.

### PART NUMBER DESCRIPTION

100—chainsaw, 10—housing, 20—driving assembly, 30—transmission assembly, 40—power supply assembly, 50—cutting assembly, 11—first housing, 12—second housing, 101—central housing, 102—motor cover, 103—handle housing, 1030—switch, 104—hollow structure, 1021—air outlet, 1022—first air inlet, 23—heat dissipation fan, 1023—second air inlet, 1024—blocking plate, 1025—soft rubber, 1026—holding area, 107—first protective plate, 108—second protective plate, 14—side cover, 1401—concave groove, 141—locking knob, 142—locking bolt, 51—bar, 143—nut, 144—locking handle, 151—tensioning block, 121—sliding groove, 122—pin shaft, 123—clamping groove, 124—limiting groove, 1511—first connecting component, 1512—second connecting component, 152—spiral cam, 153—tensioning knob, 1521—convex outer arm, 1522—crescent—shaped through hole, 1531—crescent—shaped protruding block, 125—spring, 154—flat spring, 1532—protrusion, 1031—housing cavity, 1032—first positioning rib, 1033—second positioning rib, 105—brushless PCB board, 106—brushed PCB board, 10331—upper rib position, 10332—lower rib position, 21—brushless motor, 22—brushed motor, 1034—auxiliary air inlet, 202—wire, 2021—wire clamping groove, 2022—first guiding wire groove, 2023—second guiding wire groove, 31—driving wheel, 32—driven wheel, 33—output shaft, 34—bearing, 109—bearing installation position, 24—motor bracket, 25—fixing screw, 16—semi—limiting groove, 17—motor bracket installation groove, 171—protruding rib, 1071—concave groove, 1072—rotating shaft, 1073—torsion spring, 1074—bushing, 1075—gasket.

### DETAILED DESCRIPTION

The following describes the implementation of the disclosure through specific embodiments, and those skilled in the art can easily understand other advantages and effects of the disclosure from the content disclosed in this specification. The disclosure may also be implemented or applied through other different specific embodiments. Various details in this specification may also be modified or changed based on different viewpoints and applications without departing from the disclosure.

It should be noted that drawings provided in the embodiments are only illustrative of a basic idea of the disclosure. The drawings only show assemblies related to the disclosure instead of drawing according to the number, shape and size of the assemblies in actual implementation. In actual implementation, the type, quantity and ratio of each assembly may be changed at will, and a layout of the assemblies may also be more complicated.

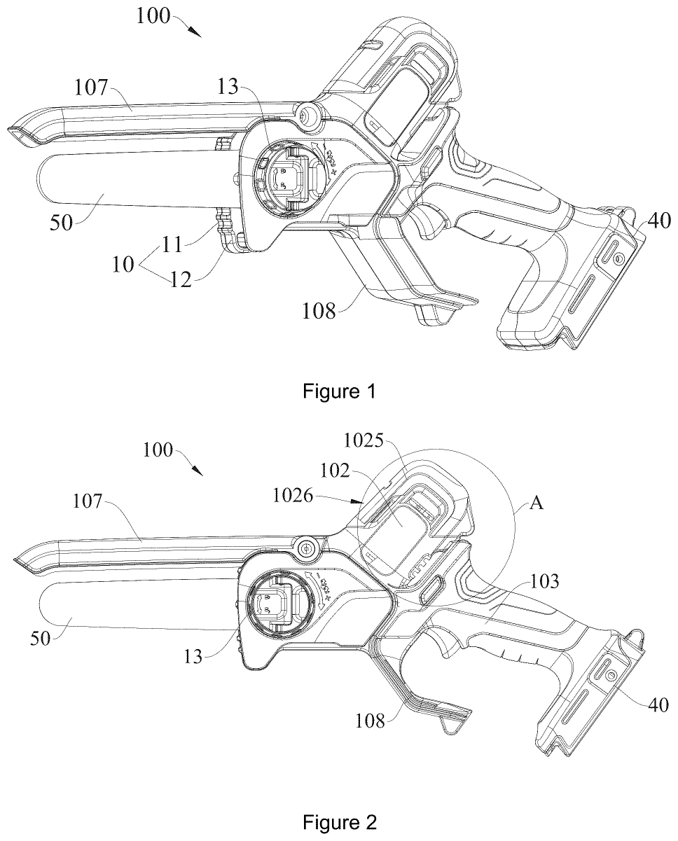

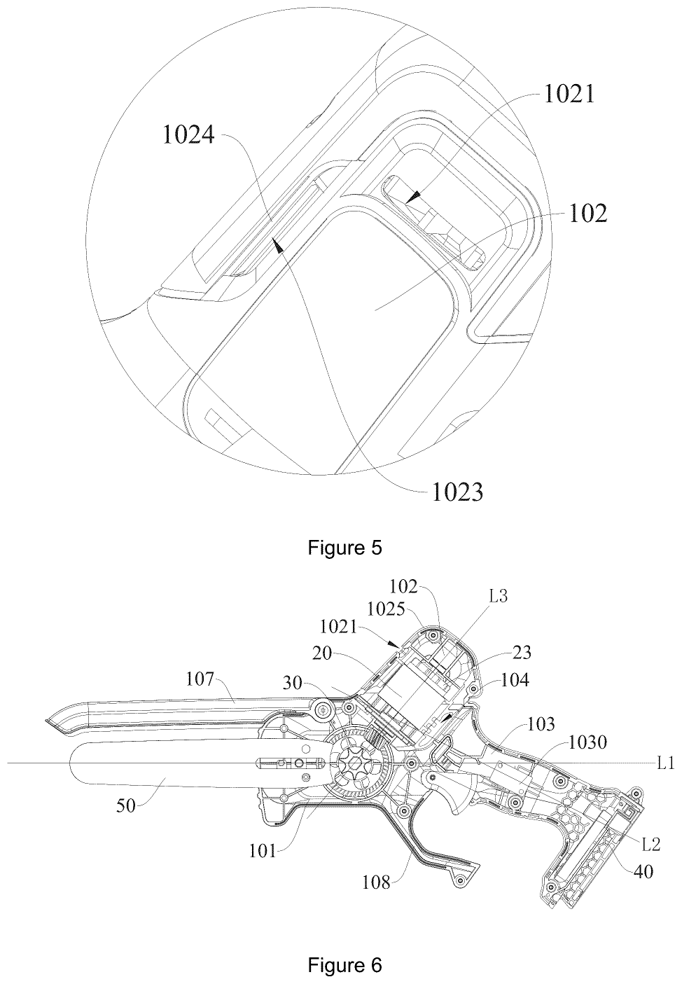

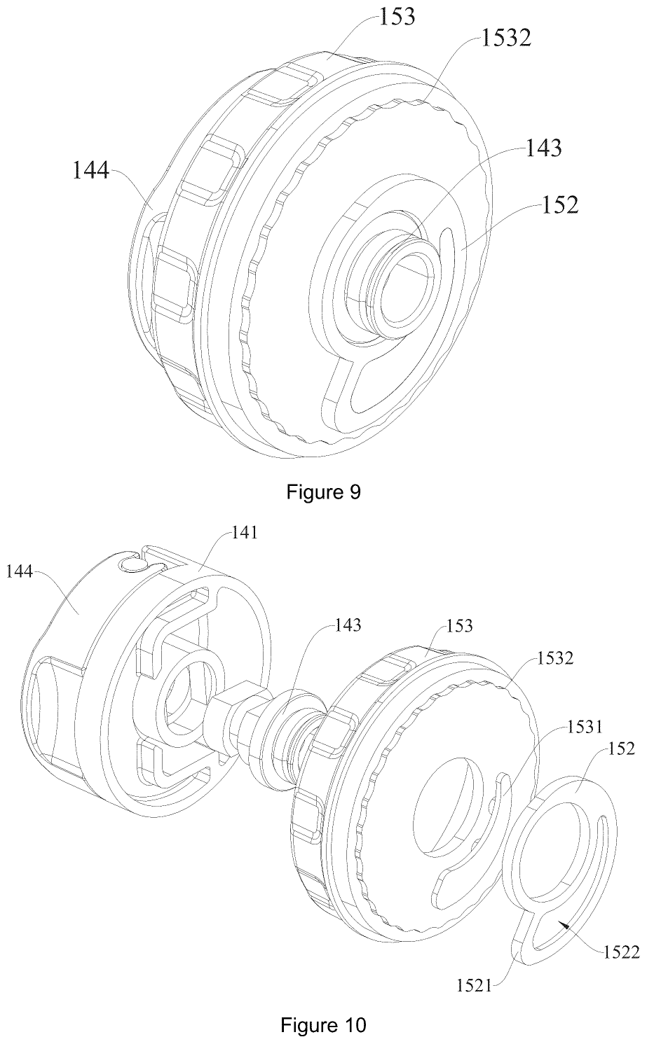

Please refer to FIG. 1 through FIG. 10. The disclosure provides a chainsaw to improve problems of conventional chainsaws that a motor and a handle are roughly arranged on a same horizontal line, vibration generated during an operation of the motor is not conducive to hold the handle, a way of holding the chainsaw is not conducive to a human body to exert force, and a structure does not conform to a principle of ergonomics. Specifically, in this embodiment, the chainsaw 100 includes a housing 10, a driving assembly 20, a transmission assembly 30, a power supply assembly 40 and a cutting assembly 50. The driving assembly 20 and the transmission assembly 30 are arranged in the housing 10, the cutting assembly 50 is arranged at a front side of the housing 10, and the driving assembly 20 is connected with the transmission assembly 30. At the same time, the transmission assembly 30 is connected with the cutting assembly 50, and the transmission assembly 30 is driven by the driving assembly 20, thereby driving the cutting assembly 50 to cut. The power supply assembly 40 is electrically connected with the driving assembly 20, and the power supply assembly 40 is connected with an external power supply or battery pack to provide a power source for the driving assembly 20.

Please refer to FIG. 1 and FIG. 2. In this embodiment, the housing 10 includes a first housing 11 and a second housing 12, the first housing 11 and the second housing 12 are fixedly connected with each other to form a housing cavity, and the driving assembly 20 and the transmission assembly 30 are installed in the housing cavity. The housing 10 includes a central housing 101, a motor cover 102 and a handle housing 103, which means that the first housing 11 and the second housing 12 both include a central housing part, a motor cover part and a handle housing part. It should be noted that, in this embodiment, the central housing 101, the motor cover 102 and the handle housing 103 are an integrally formed structure, wherein the central housing 101 is a part for installing the transmission assembly 30, the motor cover 102 is a part for installing the driving assembly 20, and the handle housing 103 is a handle part. The battery pack is plugged into an end part of the handle housing 103 to be connected with the power supply assembly 40 to provide the power source for the driving assembly 20.

Please refer to FIG. 1, FIG. 2 and FIG. 6. In this embodiment, the transmission assembly 30 is installed in the central housing 101, the driving assembly 20 is installed in the motor cover 102, and an output shaft of the driving assembly 20 extends into the central housing 101 and is connected with the transmission assembly 30 installed in the central housing 101. The cutting assembly 50 is installed on a front side of the central housing 101 and is partially located inside the central housing 101 to be connected with the transmission assembly 30. The transmission assembly 30 is driven by the driving assembly 20, and then the cutting assembly 50 is driven to mow.

Please refer to FIG. 1, FIG. 2 and FIG. 6. In this embodiment, a switch 1030 is installed inside the handle housing 103, and the power supply assembly 40 is installed at a tail part of the handle housing 103. The power supply assembly 40 is connected with the external power source, and the power supply assembly 40, the driving assembly 20 and the switch 1030 are electrically connected with each other. Specifically, the switch 1030, the driving assembly 20 and the power supply assembly 40 are electrically connected with each other through a conductive wire. The conductive wire is led out from the power supply assembly 40, passes through an inside of the handle housing 103 and is connected with the switch 1030, and extends into the motor cover 102 to be connected with the driving assembly 20. It should be further noted that, the driving assembly may be a brushed motor or a brushless motor and may share one set of molds, which means that the motors are interchangeable, and corresponding control boards therein are also interchangeable. The control board is installed in the housing 10 and is used to control the driving assembly 20.

Please refer to FIG. 1, FIG. 2 and FIG. 6. In this embodiment, the motor cover 102 is arranged obliquely upward at a tail part of the central housing 101, and correspondingly, the handle housing 103 is arranged obliquely downward at the tail part of the central housing 101, and a hollow structure 104 is arranged between the motor cover 102 and the handle housing 103. An arrangement of the hollow structure 104 separates the motor cover 102 and the handle housing 103 from each other, thereby effectively reducing vibration at a holding part of the handle and improving comfort and safety of users.

Please refer to FIG. 1, FIG. 2 and FIG. 6. In this embodiment, an axis L1 of the cutting assembly 50 is intersected with an axis L2 of the handle housing 103 at a first intersection, and the first intersection is located inside the handle housing 103. It should be noted that the axis of the cutting assembly 50 is a center line along a length direction (X direction) of the cutting assembly 50, and the axis of the handle housing 103 is a center line along an arrangement direction of the handle housing 103, thereby moving a center of gravity of the chainsaw 100 backward and enable the chainsaw 100 to fit ergonomic during use to improve the comfort of users. It should be further noted that, the axis L1 of the cutting assembly 50 further is intersected with an axis L3 of the motor cover 102, and a second intersection thereof is located in the central housing 101. The axis L2 of the handle housing 103 is intersected with the axis L3 of the motor cover 102, and a third intersection thereof is located in the motor cover 102.

Please refer to FIG. 1, FIG. 2 and FIG. 6. It should be further noted that, since the power supply assembly 40 is arranged at a tail part of the handle assembly 103 and a bottom surface of the power supply assembly 40 is a planar structure, the chainsaw 100 may be placed relatively vertically when a battery pack is installed or not.

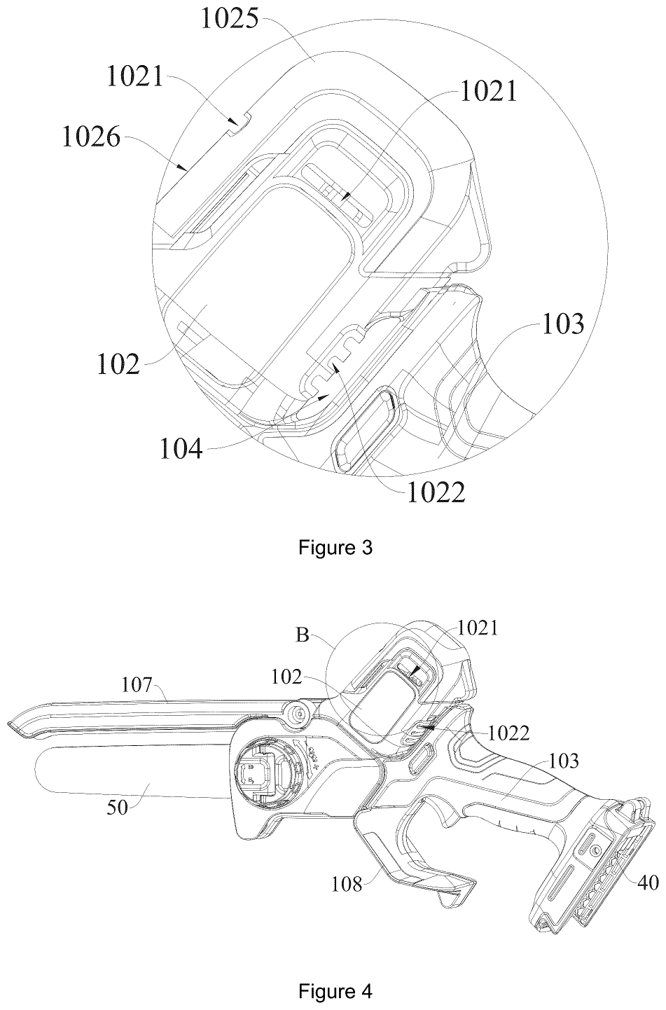

Please refer to FIG. 2, FIG. 3 through FIG. 5. In this embodiment, an air outlet 1021 is arranged near a top of the motor cover 102, and a first air inlet 1022 is further arranged on the motor cover 102. The first air inlet 1022 is arranged near the hollow structure 104 between the motor cover 102 and the handle housing 103. At the same time, a heat dissipation fan 23 is further installed at a tail part of the driving assembly 20, and the heat dissipation fan 23 is close to a top of the motor cover 102. When the heat dissipation fan 23 is started, cooling air enters the motor cover 102 from the first air inlet 1022, flows through the driving assembly 20 and then flows out from the air outlet 1021. This means that, through arranging an air inlet on the motor cover 102 and arranging the air inlet near the hollow structure 104, while achieving a heat dissipation effect on a driving motor, it is effectively prevented that debris and the like enters an interior of the chainsaw from the air inlet, thereby preventing the chainsaw from being damaged.

Please refer to FIG. 2, FIG. 3 through FIG. 5. In order to prevent the cooling air from entering the motor cover 102 from a single side, resulting in an uneven heat dissipation around the driving assembly 20 and causing a local temperature of the driving assembly 20 to be too high, in this embodiment, a plurality of second air inlets 1023 is arranged around the motor cover 102. The second air inlet 1023 is arranged obliquely on the motor cover 102, which means that there is a blocking plate 1024 formed by a cover wall of the motor cover 102 at the second air inlet 1023. While improving the heat dissipation effect, it can also prevent debris from entering the interior of the chainsaw, thereby avoiding damage to the chainsaw.

Please refer to FIG. 2, FIG. 3 through FIG. 5. In this embodiment, a soft rubber 1025 is arranged on the motor cover 102, and a holding area 1026 is arranged on a side of the motor cover 102 opposite to the hollow structure 104, so that when cutting branches, the holding area 1026 is equivalent to a front handle and is ergonomically suitable, which means that the motor cover 102 is obliquely upwardly arranged at the tail part of the central housing 101. The holding area 1026 is arranged on the side of the motor cover 102 opposite to the hollow structure 104, so that when cutting branches, an angle of the front handle is ergonomically suitable, suitable for exerting force, stable holding, and comfortable for hand feeling. At the same time, through arranging soft rubber 1025 on the motor cover 102, hand feeling comfort and friction are increased, while the vibration is reduced.

It should be further noted that, a tensioning mechanism is arranged on a side of the second housing 12 away from the first housing 11, and the tensioning mechanism is connected with the bar 51 in the cutting assembly 50. Specifically, a tensioning block is slidably installed on a side of the housing, and the bar 51 is slidably installed together with the second housing 12 through the tensioning block. A side cover is further arranged on the side of the housing where the tensioning block is arranged. The tensioning mechanism is arranged on the side cover and is used to manually adjust forward and backward movement of the bar 51 in the cutting assembly 50, thereby adjusting a tensioning of a chain blade in the cutting assembly 50, so that a tensioning of the chain may be adjusted without carrying tools, which reduces needs for tools in conventional chainsaws to achieve a tensioning of the cutting assembly 50.

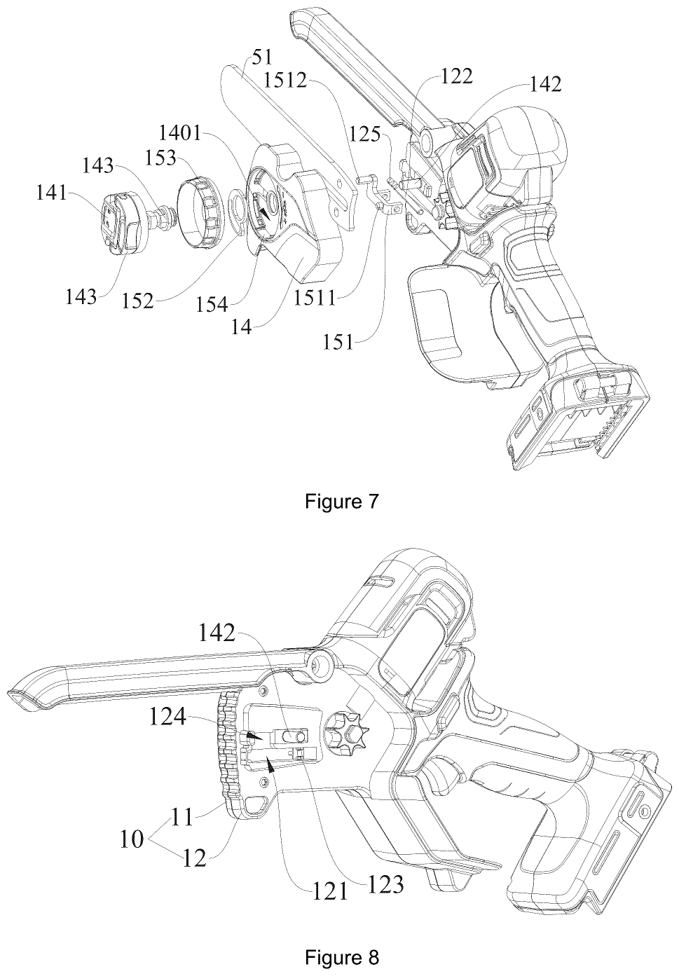

Specifically, please refer to FIG. 1, FIG. 2 and FIG. 7. In this embodiment, the side cover 14 is arranged on a side of the second housing 12 away from the first housing 11, and a housing cavity is formed between the side cover 14 and the housing 10. The bar 51 in the cutting assembly is partially located in the housing cavity. A locking knob 141 is installed on the side cover 14, and a locking bolt 142 is arranged on the second housing 12. A first end of the locking bolt 142 is fixedly connected with the second housing 12, and a second end of the locking bolt 142 passes through the second housing 12, the bar 51 and the side cover 14 in sequence to be threadedly connected with the locking knob 141. Specifically, a nut 143 is embedded in the locking knob 141, which is threadedly connected with the locking bolt 142 through the nut 143. Through tightening the locking knob 141, the side cover 14 is driven to be pressed against the bar 51, thereby achieving a locking.

Please refer to FIG. 1, FIG. 7 through FIG. 10. In this embodiment, a locking handle 144 is further installed on the locking knob 141, and the locking handle 144 is rotatably connected with the locking knob 141. The locking handle 144 is directly pressed onto the locking knob 141 for positioning, for example, through a plastic deformation of a plastic component. It should be further noted that, the locking knob 141 is provided with a plurality of angle clamping positions to fix the locking handle 144. For example, there is a clamping position at 0° and 90° respectively. The 0-degree position ensures that the locking handle 144 is accommodated in a housing groove of the locking knob 141 when the tool is in use, and the locking handle 144 does not swing back and forth. The 90-degree clamping position ensures that when the locking handle 144 is rotated, the handle is always kept at 90 degrees for an easy rotation.

Please refer to FIG. 1, FIG. 7 through FIG. 10. In this embodiment, the tensioning mechanism is arranged on the side cover 14 for manually adjusting the forward and backward movement of the bar 51 in the cutting assembly, thereby adjusting the tensioning of the chain in the cutting assembly, so that the tensioning of the chain may be adjusted without carrying tools, which reduces the needs for tools in conventional chainsaws to achieve the tensioning of the cutting assembly. A concave groove 1401 is arranged on the side cover 14, and a tensioning knob 153 is installed in the concave groove 1401. The tensioning knob 153 is rotatably connected with the side cover 14, and the locking knob 141 is rotatably installed in a middle of the tensioning knob 153.

Please refer to FIG. 1, FIG. 7 through FIG. 10. In this embodiment, the bar 51 in the cutting assembly is slidably connected with the housing 10 through the tensioning block 151. A sliding groove 121 is arranged on one side of the second housing 12 close to the side cover 14. The tensioning block 151 is slidably installed in the sliding groove 121. Specifically, a pin shaft 122 is installed in the sliding groove 121, and the tensioning block 151 is slidably installed on the pin shaft 122. It should be noted that, a clamping groove 123 is arranged at one end of the sliding groove 121, a first end of the pin shaft 122 is inserted into an inner side wall of the sliding groove 121, and a second end of the pin shaft 122 is clamped into the clamping groove 123. During installation, the tensioning block 151 is first installed on the pin shaft 122, and then the pin shaft 122 is installed in the sliding groove 121. This method of installing the pin shaft 122 enables its structure to be stable, and an installation of the pin shaft 122 does not require other parts to install and fix the pin shaft 122, which saves costs and optimizes a complexity of the structure. It is also convenient for personnel to install, and no tools are required for installation, only manual installation is required, and the installation time is saved.

Please refer to FIG. 1, FIG. 7 through FIG. 10. It should be noted that, in this embodiment, a limiting groove 124 is further arranged above the sliding groove 121, and the tensioning block 151 is partially located in the limiting groove 124 to limit the tensioning block 151 when it slides, thereby preventing the tensioning block 151 from excessively moving that may cause the bar 51 to be over-tensioned and damaged.

Please refer to FIG. 1, FIG. 7 through FIG. 10. In this embodiment, a first connecting component 1511 and a second connecting component 1512 are arranged on the tensioning block 151. The first connecting component 1511 is arranged at a first end of the tensioning block 151, and the first connecting component 1511 is fixedly connected with the bar 51, and is used to drive the bar 51 to move synchronously when the tensioning block 151 moves. The second connecting component 1512 is arranged at a second end of the tensioning block 151, and one end of the second connecting component 1512 passes through an oblong through groove on the bar 51 and the side cover 14, and is used to contact with a spiral cam 152, so as to push the tensioning block 151 to move through the spiral cam 152.

Please refer to FIG. 1, FIG. 7 through FIG. 10. In this embodiment, the spiral cam 152 is rotatably installed on the side cover 14, and the tensioning knob 153 is rotatably installed in the concave groove 1401. Specifically, the spiral cam 152 is rotatably installed at a bottom of the concave groove 1401, and is located between the tensioning knob 153 and the side cover 14. A convex outer arm 1521 is arranged on an outer circumference of the spiral cam 152. The convex outer arm 1521 is a portion where an outer circumference radius of the spiral cam 152 where the outer gradually increases. During a rotation of the spiral cam 152, the convex outer arm 1521 is fitted with the second connecting component 1512 on the tensioning block 151, as the spiral cam 152 rotates, the tensioning block 151 is pushed to move, and then the bar 51 is driven to move under a driving action of the first connecting component 1511, thereby realizing the tensioning of the cutting assembly. It should be noted that, the spiral cam 152 is, for example, a metal component to ensure its duration life and reliability.

Please refer to FIG. 1, FIG. 7 through FIG. 10. In this embodiment, a crescent-shaped through hole 1522 is arranged on the spiral wheel 152, and a crescent-shaped protruding block 1531 matched with the crescent-shaped through hole 1522 is arranged on the tensioning knob 153, and the crescent-shaped protruding block 1531 is located in the crescent-shaped through hole 1522, so that the tensioning knob 153 and the spiral cam 152 are engaged together, and the tensioning knob 153 is rotatably installed on an outer side of the locking knob 141, which means that the tensioning knob 153 is rotatably installed on the side cover 14. The spiral cam 152 is driven to rotate by rotating the tensioning knob 153, thereby driving the tensioning block 151 to move.

It should be further noted that, please refer to FIG. 1, FIG. 7 through FIG. 10. In this embodiment, a spring 125 is sleeved on the pin shaft 122, and the spring 125 is located between the tensioning block 151 and an inner side wall of the sliding groove 121 into which the pin shaft 122 is inserted. The tensioning knob 153 is rotated clockwise to drive the spiral cam 152 to move clockwise, and the spiral cam 152 rotates so that the convex outer arm 1521 on an outer circumference of the spiral cam 152 touches the tensioning block, and drives the tensioning block 151 to move linearly in an axis direction of the pin shaft 122, which means that the tensioning block 151 moves in a translational motion while driving the bar 51 to move in the translational motion, so as to realize a tensioning of the tensioning structure. When the tensioning knob 153 is rotated counterclockwise to drive the spiral cam 152 to move counterclockwise, the tensioning will be relaxed at the same time, and an elastic deformation of the spring 125 drives the tensioning block 151 to move in the translational motion, so that the tensioning block 151 returns to its original position, thereby realizing an automatic resetting.

Please refer to FIG. 1, FIG. 7 through FIG. 10. In this embodiment, a flat spring 154 is installed on an inner side wall of the concave groove 1401, and a plurality of protrusions 1532 is arranged at intervals on an outer circumference of a bottom surface of the tensioning knob 153. The flat spring 154 is located between the inner side wall of the concave groove 1401 and an outer side wall of the tensioning knob 153. When the tensioning knob 153 is rotated, the plurality of protrusions 1532 is pressed on the flat spring 154 at intervals, which means that the flat spring 154 performs an elastic deformation movement in a process of back and forth transforming between the protrusion 1532 and the gap between the two protrusions 1532, thereby generating sound and damping feeling, which is convenient for accurately adjusting the tensioning.

In summary, the disclosure provides the chainsaw, which integrates the tensioning knob and the locking knob together to facilitate user operation, realizes integrated functions of tensioning and pressing of the chain and the plate in a tensioning and locking structure, and realizes tool-free adjustment. And by arranging the flat spring between the tensioning knob and the side cover, and the flat spring is elastically deformed during rotation, thereby generating the sound and damping feeling, which it convenient for accurately adjusting the tensioning.

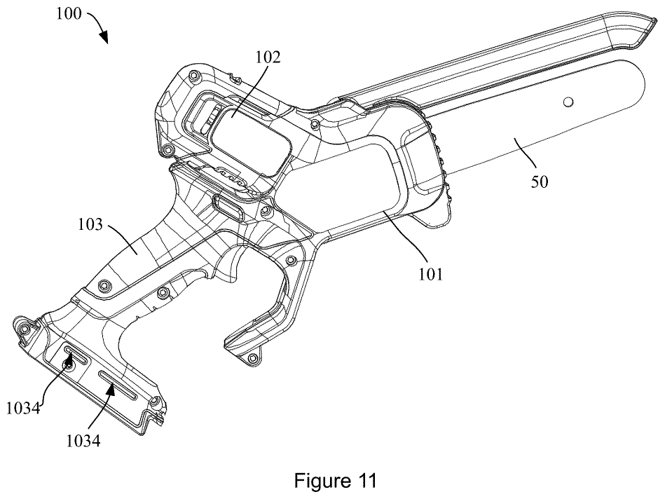

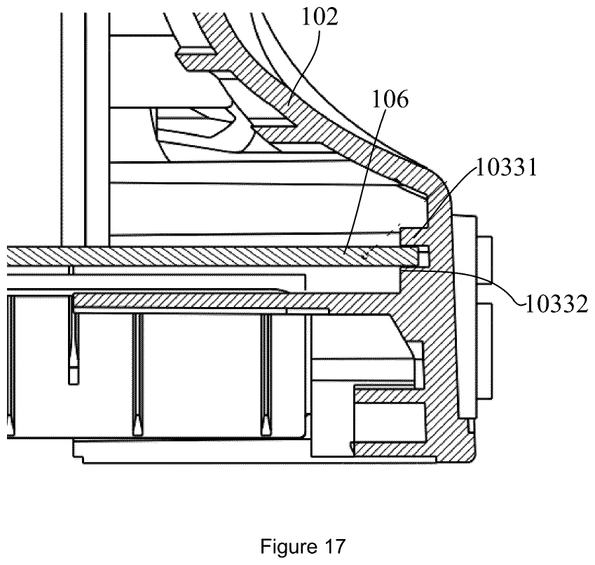

Please refer to FIG. 11 through FIG. 22. In this embodiment, in order to solve a problem that the electric chainsaw can generally only be used with a brushless motor and a brushless PCB board, or can only be used with a brushed motor and a brushed PCB board, which cause that the two cannot be compatible at the same time, resulting in low adaptability. Specifically, a housing cavity 1031 is formed at a bottom of the handle housing 103, and a PCB board is installed in the housing cavity 1031. Specifically, positioning ribs for fixing the PCB board are arranged on side walls of the housing cavity 1031. For example, first positioning ribs 1032 are arranged on front and rear sides of the housing cavity 1031, and second positioning ribs 1033 are arranged on left and right sides. Wherein, a side of the handle housing 103 close to the cutting assembly 50 is defined as the front side, and a side away from the cutting assembly 50 is defined as the rear side. In this embodiment, the PCB board may be a brushless PCB board 105 or a brushed PCB board 106. When the PCB board is the brushless PCB board 105, the brushless PCB board 105 is positioned by the first positioning rib 1032 and fixed in the housing cavity 1031. When the PCB board is the brushed PCB board 106, the brushed PCB board 106 is positioned by the second positioning rib 1033 and fixed in the housing cavity 1031, so that the first positioning rib 1032 and the second positioning rib 1033 with different matching are used in a same housing, which may be compatible with a size difference of the brushed PCB board 106 and the brushless PCB board 105, realize an interchangeability of the brushed motor 22 and the brushless motor 21, and has a high adaptability.

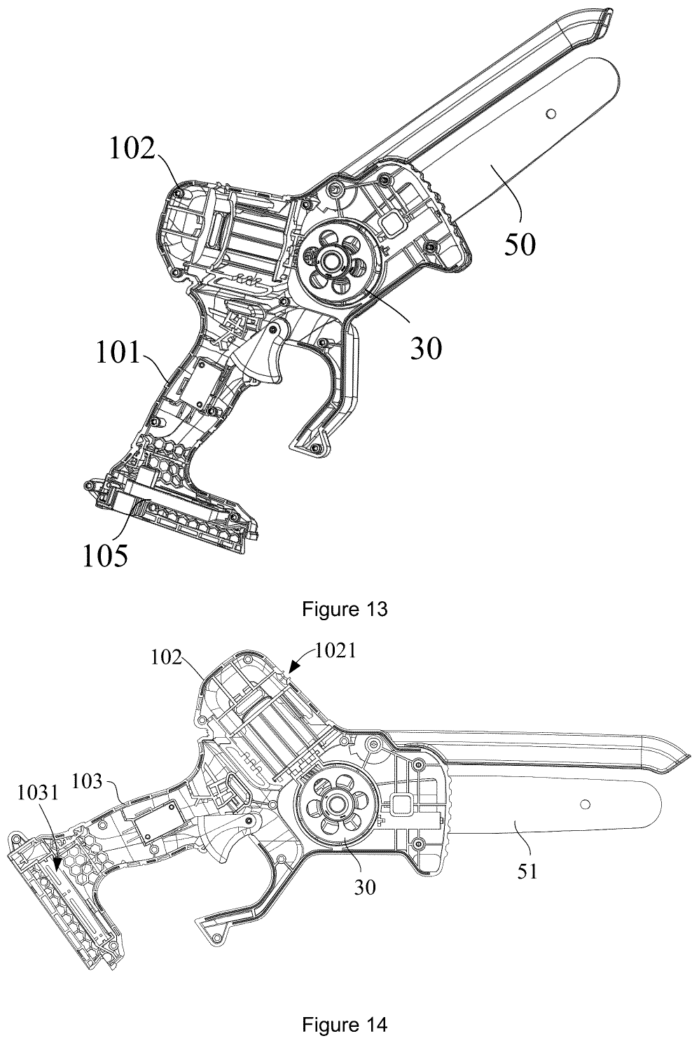

Please refer to FIG. 13 through FIG. 17. In this embodiment, since a wall thickness of the brushless PCB board 105 is relatively large, an enclosing rib position is adopted for fixing, which means that the first positioning rib 1032 surrounds and fixes the brushless PCB board 105. A wall thickness of the brushed PCB board 106 is relatively thin, so a design of inserting a side surface of the brushed PCB board 106 into two ribs is adopted for fixing, which means that the second positioning rib 1033 includes an upper rib position 10331 and a lower rib position 10332, and there is a gap between the upper rib position 10331 and the lower rib position 10332. The brushed PCB board 106 is inserted into the gap between the upper rib position 10331 and the lower rib position 10332, and a fixed installation is achieved through a matching of the upper rib position 10331 and the lower rib position 10332, so that the handheld chainsaw can be adapted to install the brushed PCB board and the brushless PCB board at the same time, thereby improving an applicability of the handheld chainsaw.

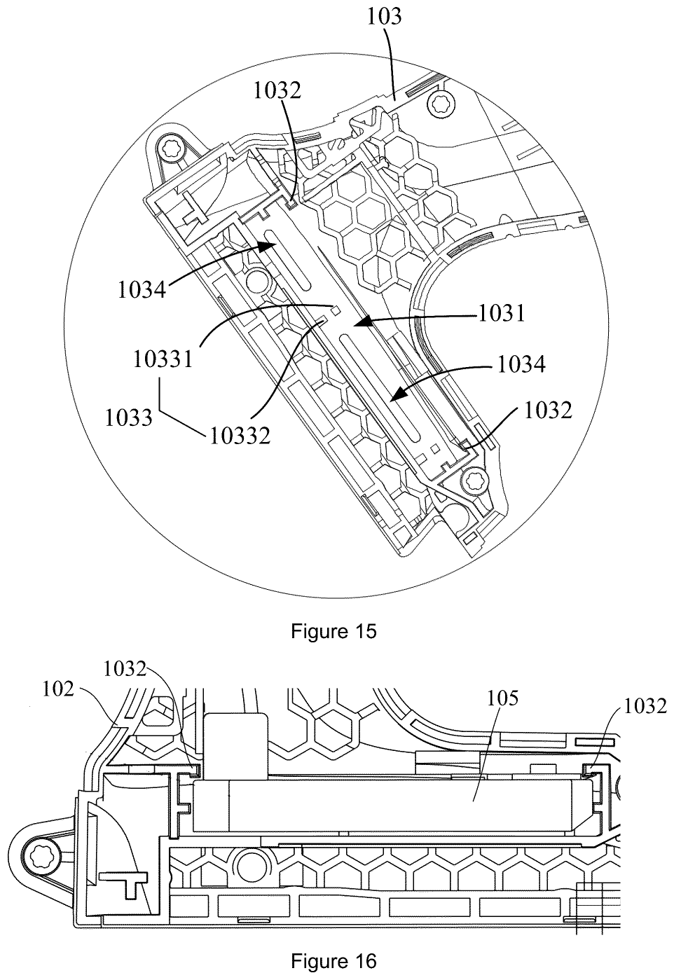

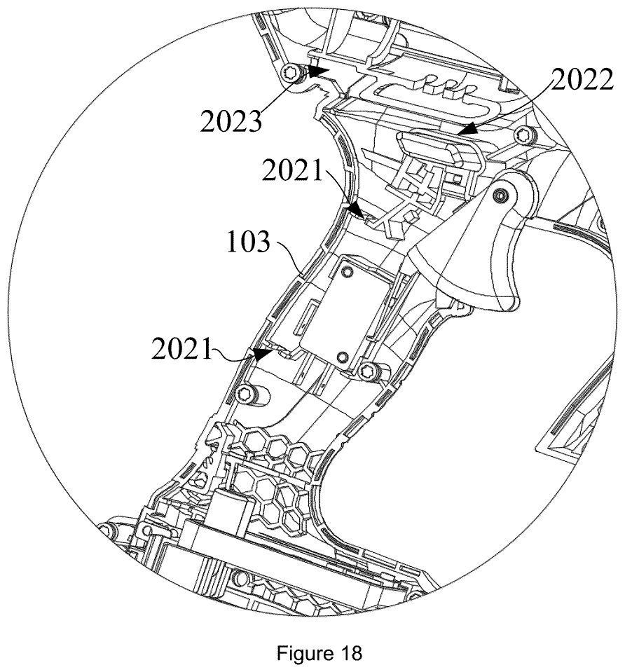

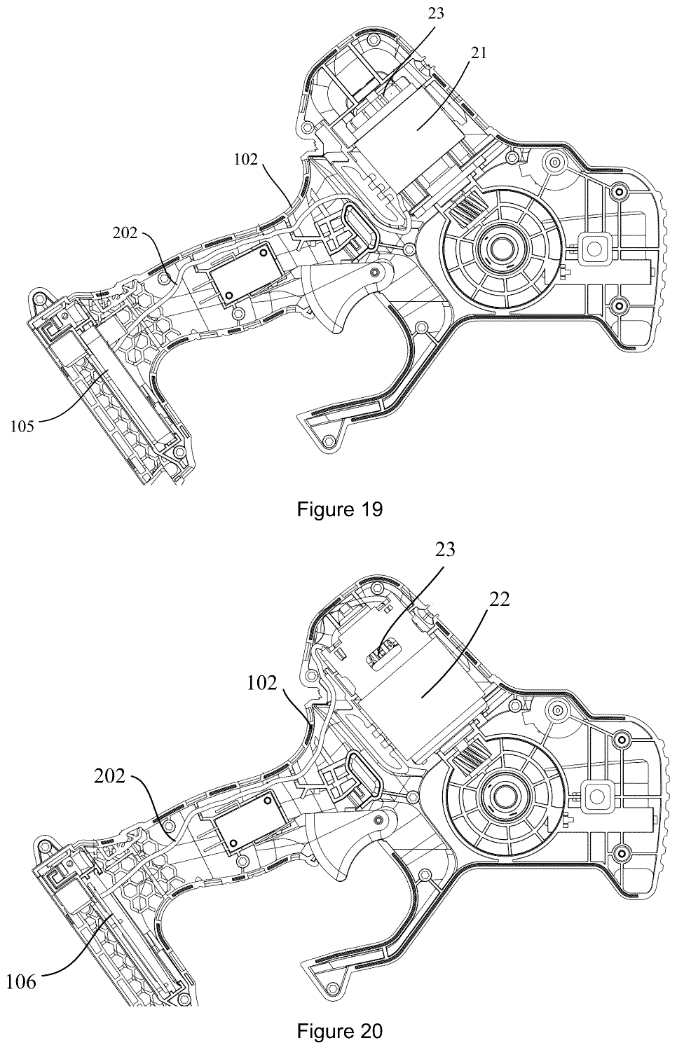

Please refer to FIG. 15, FIG. 18, FIG. 19 and FIG. 20. In this embodiment, the driving assembly 20 is a motor, which is installed in the motor cover 102. For example, when the PCB board is the brushless PCB board 105, the motor is a brushless motor 21, and when the PCB board is the brushed PCB board 106, the motor is a brushed motor 22, so that the handheld chainsaw can be adapted to install the brushed PCB board 106 and the brushless PCB board 105 at the same time, a corresponding motor is selected according to a type of its PCB board, and the handheld chainsaw can adapt to different types of motors, thereby improving the applicability of the handheld chainsaw. It should be noted that, a heat dissipation fan 23 is arranged at a tail part of the motor, and the heat dissipation fan 23 is close to a top of the motor cover 102. Correspondingly, the air outlet 1021 is arranged on the motor cover 102. When the heat dissipation fan 23 is started, cooling air enters the motor cover 102 from the air inlet, flows through the motor, and then flows out from the air outlet 1021, so as to achieve a heat dissipation effect on the motor.

Please refer to FIG. 13 through FIG. 17. In this embodiment, an auxiliary air inlet 1034 is arranged on the first housing 11 and the second housing 12 at positions corresponding to the housing cavity 1031. The auxiliary air inlet 1034 is connected with the housing cavity 1031 so that the brushed PCB board and the brushless PCB board can share the air inlet to achieve an auxiliary heat dissipation and a natural heat dissipation of the PCB board, thereby further improving the heat dissipation effect of the chainsaw 100.

Please refer to FIG. 15, FIG. 18, FIG. 19 and FIG. 20. In this embodiment, the motor and the PCB board are electrically connected through a wire 202. A first end of the wire 202 is electrically connected with the PCB board, and a second end of the wire 202 passes through an interior of the handle housing 103, extends into the motor cover 102 and is electrically connected with the motor. Specifically, a wire clamping groove 2021 is arranged on an inner wall of a part of the first housing 11 or the second housing 12 located at the handle housing 103, and the wire 202 is fixed in the wire clamping groove 2021. The wire clamping groove 2021 for fixing the wire connected between the PCB board and the motor is arranged in the housing 10 to adapt to a wire routing of different motor types, thereby avoiding dangers or unreliability caused by messy wires.

Please refer to FIG. 15, FIG. 18, FIG. 19 and FIG. 20. In this embodiment, when the motor is the brushless motor 21, the wire 202 is led out from a front side of the brushless motor 21 and connected to the brushless PCB board 105. At this time, a first guiding wire groove 2022 is arranged on the first housing 11 near the front side of the brushless motor 21 or the second housing 12 near the front side of the brushless motor 21. At this time, the wire 202 extends from the front side of the brushless motor 21 to the brushless PCB board 105 and passes through the first guiding wire groove 2022 and the wire clamping groove 2021 in sequence. When the motor is the brushed motor 22, the wire 202 is led out from a rear side of the brushed motor 22 and connected to the brushed PCB board 106. At this time, a second guiding wire groove 2023 is arranged on the first housing 11 near the rear side of the brushed motor 22 or the second housing 12 near the rear side of the brushed motor 22. At this time, the wire 202 extends from the rear side of the brushed motor 22 to the brushed PCB board 106, and passes through the second guiding wire groove 2023 and the wire clamping groove 2021 in sequence. It should be noted that, the first guiding wire groove 2022, the second guiding wire groove 2023 and the wire clamping groove 2021 are located on the first housing 11 at the same time or on the second housing 12 at the same time, and the first guiding wire groove 2022 and the second guiding wire groove 2023 are located below the motor to adapt to the wire routing of different motor types, thereby avoiding danger or unreliability caused by messy wires.

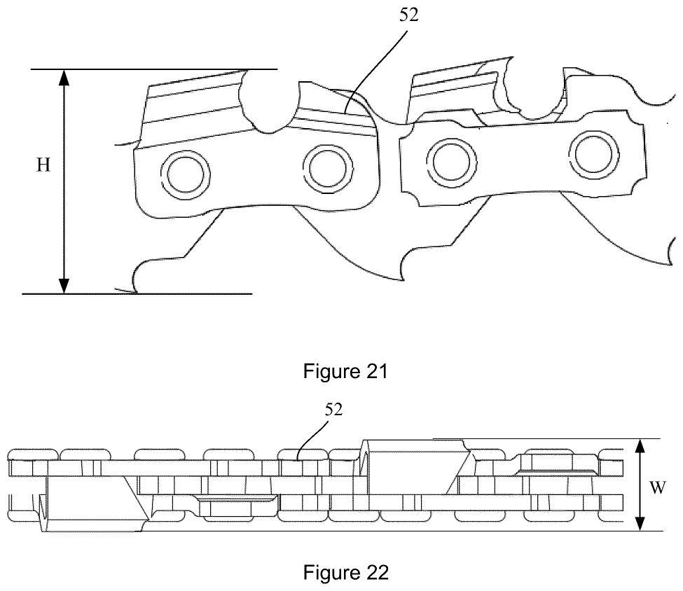

Please refer to FIG. 11 through FIG. 14, FIG. 21 and FIG. 22. In this embodiment, the cutting assembly 50 includes the bar 51 and the chain 52. One end of the bar 51 is connected with the housing 10, and the chain 52 is arranged around the bar 51. The chain 52 includes guiding teeth, and a tooth thickness of the guide teeth is set between 0.04 inches and 0.05 inches. A pitch of the chain is set between 0.2 inches and 0.4 inches. For example, the tooth thickness of the guide teeth is preferably 0.043 inches, and the pitch of the chain is preferably 0.3 inches. That means that under a same length of the chain, a number of cutting teeth of the chain with a small pitch is increased, which is beneficial to improve cutting efficiency. Furthermore, a product ratio of the chain is set between 406 mm³ and 450 mm³. Wherein, the product ratio refers to a product of a height H of the chain, the pitch of the chain and a width W of the chain, so as to increase a cutting speed, which is suitable for fast operation of small tools. Furthermore, a blade of the chain is preferably right-angle teeth or small right-angle teeth, so that a faster cutting speed and cutting efficiency can be achieved. It should be further noted that, in this embodiment, the chain preferably adopts a narrow-cut blade, which can reduce weight and rebound, improve the cutting efficiency, and cut less wood chip fibers.

In summary, in this embodiment, the housing cavity for installing the PCB board is formed in the handle housing, and the first positioning rib for fixing a brushless PCB board and the second positioning rib for fixing the brushed PCB board are respectively arranged on the side walls of the housing cavity, so that the handheld chainsaw can be adapted to be installed with the brushed PCB board and the brushless PCB board at the same time, and the corresponding motor is selected according to the type of the PCB board, and the handheld chainsaw can be adapted to different types of motors, thereby improving an applicability of the handheld chainsaw. This means that a mutual conversion between brushless motor and brushed motor in the same casing can be realized, which is compatible with brushed PCB boards and brushless PCB boards, has high adaptability, is easy to use and has a simple structure.

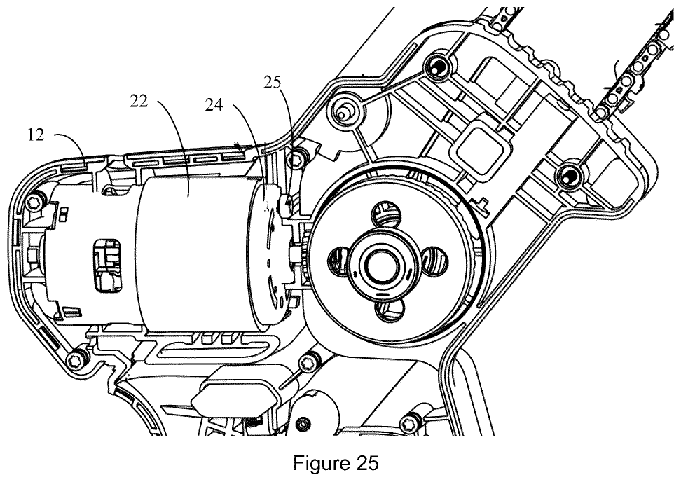

Please refer to FIG. 11 through FIG. 13 and FIG. 23 through FIG. 28. In this embodiment, in order to eliminate an influence of an axial error of the driving wheel, improve a matching accuracy of the driving wheel and the driven wheel, and prevent problems such as gear noise, tooth jamming, tooth jumping, slipping or wear, specifically, the motor includes a motor bracket 24, and the motor bracket 24 is fixedly connected with the first housing 11 and the second housing 12 by fixing screws 25. In this embodiment, the motor bracket 24 may be set as a square plate. For example, the fixing screw 25 can be fixed on the square plate, and then a cylindrical head of the fixing screw 25 is fixed in the housing 10, which means that the fixing screw 25 is engaged and fixed through an action between the first housing 11 and the second housing 12, so as to achieve a fixed installation of the motor. For example, a semi-limiting groove 16 is arranged on an inner side of the first housing 11 and the second housing 12. When the first housing 11 and the second housing 12 are fixedly installed, the two semi-limiting grooves 16 on inner sides of the first housing 11 and the second housing 12 are combined to form a complete limiting hole, and the fixing screw 25 is engaged in the limiting hole to achieve a fixation. It should be noted that, the motor may be an external rotor brushless motor.

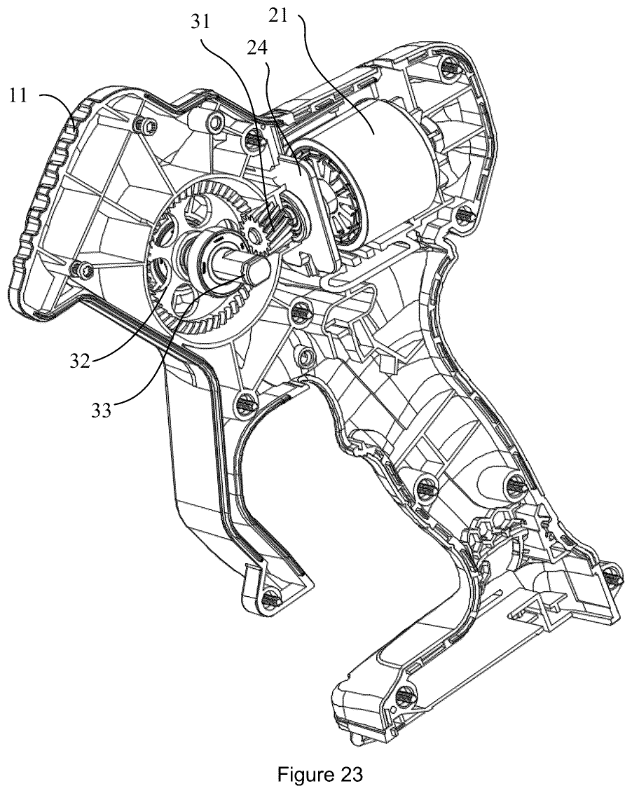

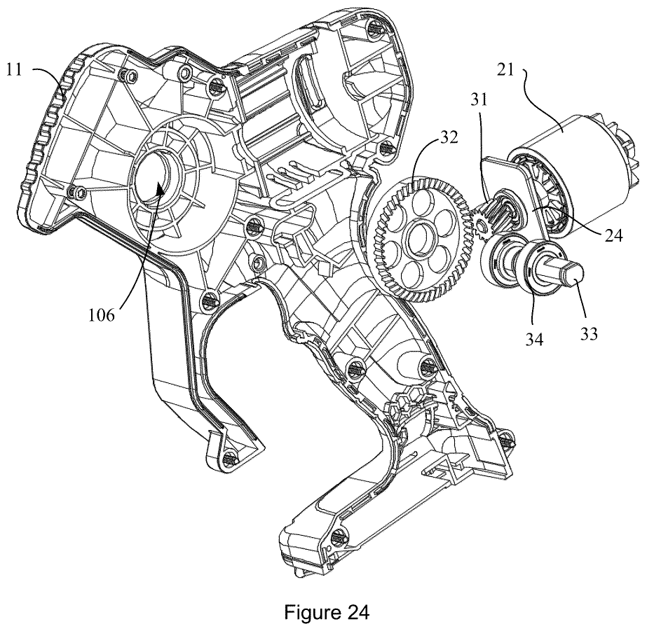

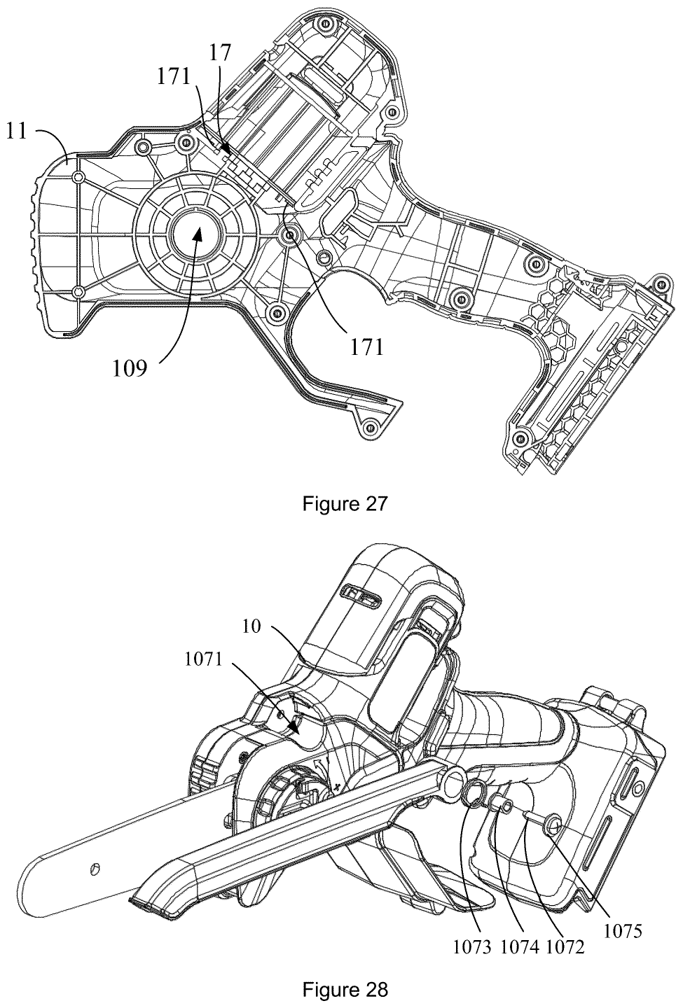

Please refer to FIG. 11, FIG. 23, FIG. 24 and FIG. 27. In another embodiment, a motor bracket installation groove 17 is formed in the first housing 11 and the second housing 12, and the motor bracket 24 is located in the motor bracket installation groove 17. For example, protruding ribs 171 are respectively formed on upper and lower sides of the motor bracket installation groove 17, and upper and lower sides of the motor bracket 24 are respectively in contact with the protruding ribs 171, which means that the upper and lower sides of the motor bracket 24 are restricted by the protruding ribs 171 on the upper and lower sides of the motor bracket installation groove 17, and left and right sides of the motor bracket 24 are restricted by the first housing 11 and the second housing 12 respectively, so that the motor is fixedly installed in the housing 10. It should be noted that, the motor is, for example, the brushed motor or an internal rotor brushless motor. Wherein, the motor bracket 24 of the brushed motor may be configured as an integral structure with the motor.

Please refer to FIG. 21, FIG. 22, FIG. 23 and FIG. 24. In this embodiment, the transmission assembly 30 includes a driving wheel 31, a driven wheel 32 and an output shaft 33. The driving wheel 31 is connected with the motor, the output shaft 33 is installed inside the housing 10, and the driven wheel 32 is installed on the output shaft 33 and meshed with the driving wheel 31. In this embodiment, for example, the driving wheel is set as a cylindrical gear, teeth of the driven wheel 32 are arranged on an end surface of the driven wheel 32, which means that a tooth trace of the driven wheel 32 is located on its end surface. The driving wheel 31 is meshed with the driven wheel 32 and a meshing surface between the driving wheel 31 and the driven wheel 32 is a flat plane, so that the driving wheel 31 is allowed to have a certain amount of movement in the axial direction, thereby improving a matching accuracy of the driving wheel and the driven wheel. Of course, the driving wheel 31 may be a cylindrical spur gear or a cylindrical bevel gear, and a tooth trace of the driving wheel 31 is preferably spiral. The driven wheel 32 adopts the crown gear, preferably a royal crown gear, and the tooth trace of the driven wheel 32 is spiral. The royal crown gear is meshed with the cylindrical gear with the spiral tooth trace, and the meshing surface is the flat plane. Therefore, when the driving wheel 31 has an axial movement, it can also ensure that the driving wheel 31 and the driven wheel 32 are automatically meshed, so that the matching accuracy of the driving wheel 31 and the driven wheel 32 is not affected by the axial error of the driving wheel 31, and an assembly is simple. At the same time, the matching accuracy of the driving wheel 31 and the driven wheel 32 is improved, and the problems of gear noise, tooth jamming, tooth jumping, slipping or wear are prevented.

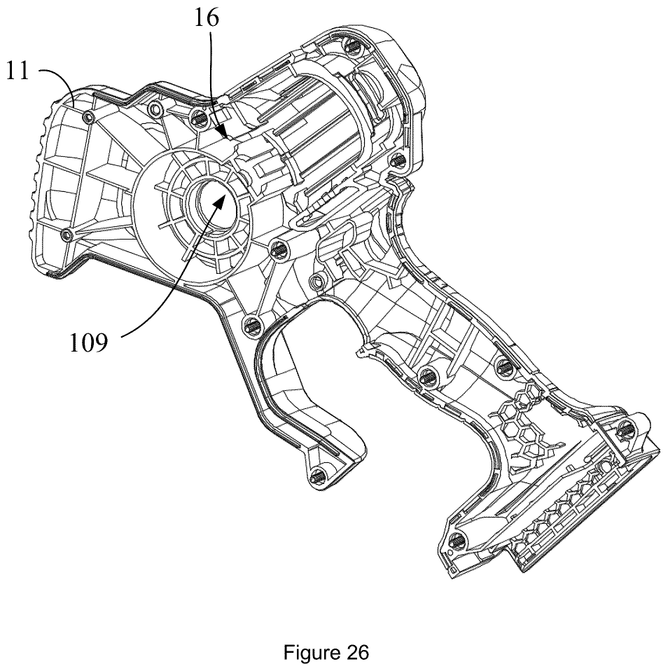

Please refer to FIG. 11, FIG. 26 and FIG. 27. In this embodiment, bearing installation positions 109 are arranged in the first housing 11 and the second housing 12, bearings 34 are installed at two ends of the output shaft 33, and the bearings 34 are located in the bearing installation positions 109 to ensure an installation accuracy of the output shaft 33.

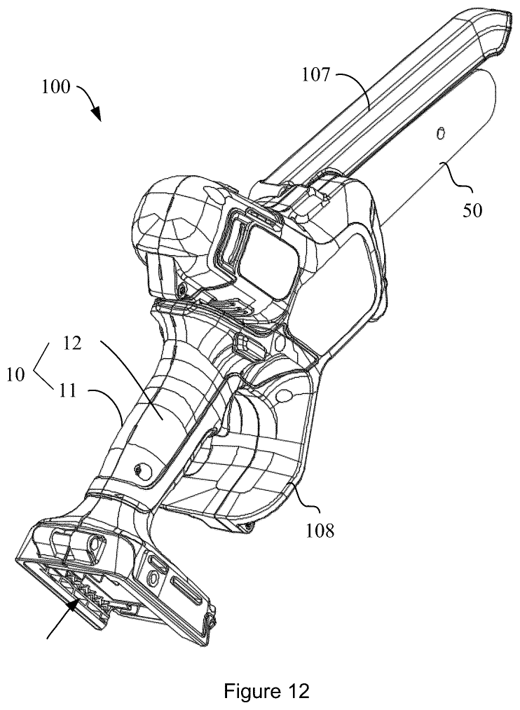

Please refer to FIG. 12 and FIG. 28. In this embodiment, the chainsaw 100 further includes a first protective plate 107. The first protective plate 107 is arranged above the cutting assembly 50 and is adapted to the cutting assembly 50. One end of the first protective plate 107 is rotatably connected with a top of the housing 10 to protect the user during a cutting process.

Please refer to FIG. 12 and FIG. 28. In this embodiment, a concave groove 1071 is arranged on the top of the housing 10, and the concave groove 1071 is located at one end of the housing 10 close to the cutting assembly 50. One end of the first protective plate 107 is located in the concave groove 1071. Specifically, a rotating shaft 1072 is arranged on the end of the first protective plate 107 that is rotatably connected with the housing 10, and a torsion spring 1073 is sleeved on the rotating shaft 1072. The rotating shaft 1072 and the torsion spring 1073 are both located in the concave groove 1071, a first end of the torsion spring 1073 is clamped on the first protective plate 107, and a second end of the torsion spring 1073 is clamped on the housing 10, so that the first protective plate 107 may be automatically reset under an action of the torsion spring 1073 after rotation. In this embodiment, a rotating angle of the first protective plate 107 is limited by the housing 10, which means that when the first protective plate 107 contacts the housing 10, a limitation is generated, thereby preventing the first protective plate 107 from continuing to rotate. A structure is simple and no other limiting structure is required. In this embodiment, the rotating angle of the first protective plate 107 is set between 0° and 110°, wherein, at 0°, the first protective plate 107 is parallel to the bar in the cutting assembly 50. Further, since the first protective plate 107 is an active component and the first protective plate 107 relates to a safety protection, it requires sufficient structural strength. Therefore, in this embodiment, a bushing 1074 is added to the first protective plate 107. The bushing 1074 is arranged between the rotating shaft 1072 and the protective plate 107. The two cooperate to rotate, thereby increasing a duration life and a structural strength. In this embodiment, the rotating shaft 1072 is configured as a screw, for example, and the bushing 1074 is arranged in the first protective plate 107. The screw passes through a gasket 1075 and the bushing 1074 in sequence and is connected with the housing 10 to install the first protective plate 107 and the housing 10, and a rotation is realized under a cooperation of the bushing 1074.

Please refer to FIG. 12. In this embodiment, the chainsaw 100 further includes a second protective plate 108, the second protective plate 108 is fixedly arranged at a bottom of the housing 10 and is located below and close to the handle housing 103, so as to protect the user during a cutting process. For example, the second protective plate 108 is an open handle protective plate, which means that the handle protective plate extends from the casing, and the other end is hollowed out to be in an open state, so that the protective plate may be made as small as possible while meeting safety regulations, which may reduce weight. The open handle protective plate is easy to hold and feels comfortable without any sense of restraint.

Please refer to FIG. 11. In this embodiment, the chainsaw 100 further includes a lubrication device. The lubrication device is installed on the output shaft 32. The lubrication device includes an automatic oil pump. An oil outlet of the automatic oil pump points to the cutting assembly 50 to achieve an automatic lubrication. Of course, in other embodiments, the chain may also be manually lubricated by dripping oil via an adapted oil dropper bottle.

Please refer to FIG. 11. In this embodiment, the motor is an external rotor motor, a diameter of the motor is set between 30 mm and 40 mm, an iron core length of the motor is set between 20 mm and 40 mm, and a weight of the handheld chainsaw is set between 1 kg and 1.1 kg. For example, when the motor is installed with a 4-inch bar and a 4-inch chain, the weight of the handheld chainsaw is between 1 kg and 1.05 kg. When the motor is installed with a 6-inch bar and a 6-inch chain, the weight of the handheld chainsaw is between 1.05 kg and 1.1 kg, and at this weight, a peak power of the handheld chainsaw can reach 500 w, and a linear speed of the chain can reach 8 m/s, so that the chainsaw achieves characteristics of light weight, high power, high torque and high linear speed.

In summary, this embodiment eliminates an influence of an axial error of the driving wheel by designing the driving wheel in the transmission assembly as a cylindrical gear, meshing the driving wheel with the driven wheel, and setting the meshing surface as the flat plane, thereby improving a matching accuracy of the driving wheel and the driven wheel, and preventing gear noise, tooth jamming, tooth jumping, slipping or wear. Furthermore, under a structure of the transmission assembly, an assembly of the motor in a machine is very simple and convenient.

The above description is only a preferred embodiment of the disclosure and an explanation of the technical principle used. Those skilled in the art should understand that a disclosure scope involved in this disclosure is not limited to the technical solutions formed by the specific combination of the above technical features. At the same time, it should also cover other technical solutions formed by any combination of the above technical features or their equivalent features without departing from a concept of the disclosure, such as a technical solution formed by replacing the above-mentioned features with technical features with similar functions disclosed in (but not limited to) this disclosure.

Except for the technical features described in the specification, the remaining technical features are known to those skilled in the art, in order to highlight the innovative features of the disclosure, the remaining technical features will not be repeated herein.

What is claimed is:

1. A chainsaw, comprising:
a housing, the housing comprising a central housing, a motor cover and a handle housing, the motor cover arranged obliquely upward at a tail part of the central housing, the handle housing arranged obliquely downward at the tail part of the central housing, and a hollow structure arranged between the motor cover and the handle housing; and
a cutting assembly, the cutting assembly arranged on a front side of the central housing, an axis of the cutting assembly intersected with an axis of the handle housing, and a first intersection thereof located inside the handle housing.

2. The chainsaw according to claim 1, wherein, the axis of the cutting assembly is intersected with an axis of the motor cover, a second intersection thereof is located in the central housing, the axis of the handle housing is intersected with the axis of the motor cover, and a third intersection thereof is located in the motor cover.

3. The chainsaw according to claim 1, wherein, an air inlet is arranged on the motor cover, and the air inlet is located at the hollow structure.

4. The chainsaw according to claim 1, further comprising:
a driving assembly, the driving assembly installed in the motor cover;
a transmission assembly, the transmission assembly installed in the central housing, and in a transmission connection with the driving assembly and the cutting assembly respectively; and
a power supply assembly, the power supply assembly arranged at a tail part of the handle housing and electrically connected with the driving assembly.

5. The chainsaw according to claim 4, wherein, a switch is arranged in the handle housing, the switch, the driving assembly and the power supply assembly are electrically connected through a conductive wire, the conductive wire is led out from the power supply assembly, passes through an inside of the handle housing and is connected with the switch, and extends into the motor cover to be connected with the driving assembly.

6. The chainsaw according to claim 1, wherein, the cutting assembly comprises a bar, the bar is slidably installed on a side of the housing through a tensioning block, and a side cover is further arranged on the side of the housing where the tensioning block is arranged.

7. The chainsaw according to claim 6, further comprising:
a locking knob, the locking knob installed on a side of the side cover away from the housing, and a locking bolt passing through the housing, the bar and the side cover in sequence to be threadedly connected with the locking knob;
a spiral cam, the spiral cam rotatably installed on the side cover, a crescent-shaped through hole arranged on the spiral cam, a convex outer arm arranged on an outer circumference of the spiral cam, and the convex outer arm fitted with the tensioning block; and
a tensioning knob, the tensioning knob rotatably installed on an outer side of the locking knob, matched with the crescent-shaped through hole through a crescent-shaped protruding block to be clamped with the spiral cam, the tensioning knob configured to be rotated to drive the spiral cam to rotate, so as to drive the tensioning block to move forward and backward, and then drive the bar to adjust a tension.

8. The chainsaw according to claim 7, wherein, a sliding groove is arranged on the side of the housing close to the side cover, a pin shaft is installed in the sliding groove, and the tensioning block is slidably installed on the pin shaft and is located in the sliding groove.

9. The chainsaw according to claim 8, wherein, a clamping groove is arranged at one end of the sliding groove, a first end of the pin shaft is inserted into an inner side wall of the sliding groove, a second end of the pin shaft is clamped in the clamping groove, a spring is sleeved on the pin shaft, and the spring is located between the tensioning block and the inner side wall of the sliding groove into which the pin shaft is inserted.

10. The chainsaw according to claim 7, wherein, a first connecting component is arranged at a first end of the tensioning block, and a second connecting component is provided at the a second end of the tensioning block, the first connecting component is fixedly connected with the bar, and one end of the second connecting component passes through the bar and the side cover to contact the spiral cam.

11. The chainsaw according to claim 7, wherein, the side cover is provided with a concave groove, the tensioning knob is located in the concave groove, a plurality of protrusions is arranged at intervals on an outer circumference of the tensioning knob, a flat spring is installed on an inner side wall of the concave groove, and the flat spring is located between the inner side wall of the concave groove and an outer side wall of the tensioning knob.

12. The chainsaw according to claim 7, further comprising a locking handle, wherein, the locking handle is rotatably connected with the locking knob, and a plurality of angle clamping positions is arranged on the locking knob to fix the locking handle.

13. The chainsaw according to claim 7, wherein, a housing cavity is formed at a bottom of the handle housing, a PCB board is installed in the housing cavity, and the PCB board is a brushless PCB board or a brushed PCB board;
wherein, front and rear sides of the housing cavity are provided with first positioning ribs, left and right sides of the housing cavity are provided with second positioning ribs, the brushless PCB board is fixedly installed in the housing cavity through the first positioning ribs or the brushed PCB board is fixedly installed in the housing cavity through the second positioning ribs.

14. The chainsaw according to claim 13, wherein, a motor is installed in the motor cover, when the PCB board is the brushless PCB board, the motor is a brushless motor, and when the PCB board is the brushed PCB board, the motor is a brushed motor.

15. The chainsaw according to claim 14, further comprising a wire, a first end of the wire is electrically connected with the PCB board, and a second end of the wire extends through the handle housing to the motor cover and is electrically connected with the motor.

16. A chainsaw, comprising:
a housing, a motor installed in the housing;
a transmission assembly, the transmission assembly comprising a driving wheel, a driven wheel and an output shaft, the driving wheel connected with the motor, the output shaft installed inside the housing, and the driven wheel installed on the output shaft;
and a cutting assembly, the cutting assembly connected with the output shaft, and the motor driving the transmission assembly to drive the cutting assembly to work;
wherein, the driving wheel is a cylindrical gear, teeth of the driven wheel are arranged on an end surface of the driven wheel, and a meshing surface between the driving wheel and the driven wheel is a flat plane.

17. The chainsaw according to claim 16, wherein, the housing comprises a first housing and a second housing, bearing installation positions are arranged in the first housing and the second housing, bearings are installed at two ends of the output shaft, and the bearings are located in the bearing installation positions.

18. The chainsaw according to claim 17, wherein, the motor comprises a motor bracket, the motor bracket is fixedly connected with the first housing and the second housing through fixing screws.

19. The chainsaw according to claim 17, wherein, the motor comprises a motor bracket, and a motor bracket installation groove is formed in the first housing and the second housing, and the motor bracket is located inside the motor bracket installation groove.

20. The chainsaw according to claim 19, wherein, the driven wheel is a crown gear.
